(19) United States
(12) Patent Application Publication
(10) Pub. No.: US 2018/0203980 A1
(43) Pub. Date: Jul. 19, 2018

(54) SYSTEMS AND METHODS FOR MANAGING COPIES OF DATA

(71) Applicant: Vaultize Technologies Private Limited, Pune (IN)

(72) Inventor: Ankur PANCHBUDHE, Pune (IN)

(73) Assignee: Vaulitize Tecnologies Private Limited, Pune (IN)

(21) Appl. No.: 15/920,198

(22) Filed: Mar. 13, 2018

(51) Int. Cl. G06F 21/10; G06F 21/62; G06F 21/60

(52) U.S. Cl. CPC G06F 21/10; G06F 2221/0737; G06F 21/604; G06F 21/6218

(57) ABSTRACT

The embodiments herein relate to managing data present in a network and, more particularly, to managing copies of data in a network. Embodiments herein check for copies of data in a plurality of devices by comparing a block of the data with a block of data. The block of data can be a portion of the overall data. On finding at least one copy of the data, embodiments herein can perform at least one task such as encrypting the data, wiping the data and so on, related to the copies and depending on at least one policy defined by an authorized person and/or entity (an administrator).

### TECHNICAL FIELD

The embodiments herein relate to managing data present in a network and, more particularly, to managing copies of data in a network.

### BACKGROUND

Currently, sharing data by users present in a network with other users of the network, as well as with users outside the network is challenging from the perspective of users as well as an administrator of the network. The network can be an enterprise network, a network present in an organization, a personal network, a LAN (Local Area Network), a WAN (Wide Area Network), a VPN (Virtual Private Network) and so on. The users want it to be seamless and intuitive, while the administrator wants to make sure that confidential data does not fall in wrong hands and all the access is tracked.

Examples of methods of sharing data with at least one other user are sending data via email, copying, sharing a link through a message (such as email, IM (Instant Message), messaging services and so on, sharing access to data present in a server, sharing access to data present in the cloud and so on. However, current methods are unable to track who is accessing the data, when the data is being accessed, and from where (the location, the device and so on) the data is being accessed.

If an enterprise wants to find out where all the copies (or similar information) of the data reside for e-discovery or compliance reasons, it becomes difficult because the data might have been residing on the devices over which organizations have no control (such as a device belonging to the user). Consider a scenario where some confidential information was leaked and that file was shared with an external user. It could have been downloaded on a device not managed by the enterprise and passed on to another user. If the enterprise wants to wipe all the copies of the data, then the enterprise should have a way to know where the data and copies of the data are present.

### BRIEF DESCRIPTION OF THE FIGURES

The embodiments herein will be better understood from the following detailed description with reference to the drawings, in which:

FIG. 1 depicts a system for managing copies of data present in an enterprise, according to embodiments as disclosed herein;

FIG. 2 depicts a data management module, according to embodiments as disclosed herein;

FIG. 3 depicts a managed device, according to embodiments as disclosed herein; and

FIG. 4 is a flowchart depicting the process of managing copies of data, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

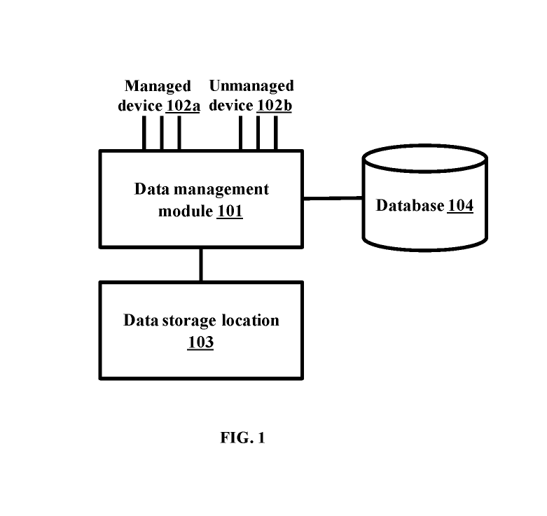

The embodiments herein disclose methods and systems for managing copies of data present within a network. Referring now to the drawings, and more particularly to FIGS. 1 through 4, where similar reference characters denote corresponding features consistently throughout the figures, there are shown embodiments.

FIG. 1 depicts a system for managing copies of data present in an enterprise, according to embodiments as disclosed herein. The system, as depicted, comprises of a data management module 101 connected to at least one database 104 and at least one data storage location 103. The data storage location 103 can be a dedicated device such as a hard disk, a SSD (Solid State Drive) and so on. The data storage location 103 can also be a part of a device associated with the enterprise network such as a desktop, a laptop, a device belonging to the user (such as in a BYOD (Bring Your Own Device) scenario) such as a mobile phone, a tablet, a personal computing device, a server, a computer, a desktop computer, a file server, an IoT (Internet of Things) device, a wearable computing device, a database server, a content server, the Cloud, and so on, wherein the data management module 101 has access to the data storage location 103.

The database 104 can comprise of at least one database. The database 104 can be a memory storage location, wherein the database 104 can be a pure database, a memory store, an electronic storage location and so on. The database 104 can be located locally with the data management module 101. The database 104 can be located remotely from the data management module 101, wherein the data management module 101 can communicate with the database 104 using a suitable means such as LAN (Local Area Network), a private network, a WAN (Wide Area Network), the Internet, Wi-Fi and so on. The database 104 can comprise of policy rule(s) (as set by the administrator), default policy rule(s), metadata and so on, related to the data.

The data management module 101 can be connected to at least one device 102. The device 102 can be at least one of a mobile phone, a tablet, a personal computing device, a computer, desktop computer, server, an IoT device, a wearable computing device, and so on. The device 102 can be connected to the data management module 101 using a suitable connection means such as a LAN, a private network, a WAN, the Internet, Wi-Fi and so on. The device 102 can comprise of at least one managed device 102a and at least one unmanaged device 102b. The managed device 102a is a device, to which the enterprise has access. The managed device 102a can be a laptop, a computer, a mobile device, an IoT device, a wearable computing device, and so on, issued by the enterprise, or approved for use by a user by the enterprise. The unmanaged device 102a is a device not associated with the enterprise and which the enterprise does not have any control over. It can belong to an employee/contractor of the enterprise and not approved for use by the enterprise. It can belong to a client/service provider of the enterprise and so on.

The data management module 101 can check for copies of data in a plurality of devices by comparing a block of the data with a block of data (already available with the data management module 101). The block of data can be a portion of the overall data. On finding at least one copy of the data, the data management module 101 can perform at least one task such as encrypting the data, deleting the data, wiping the data, DRM-protect the data and so on, related to the copies and depending on at least one policy defined by an authorized person and/or entity (hereinafter referred to as an administrator).

The data management module 101 can also enable application of DRM (Digital Rights Management) policies, in relation to the data and the copies of the data.

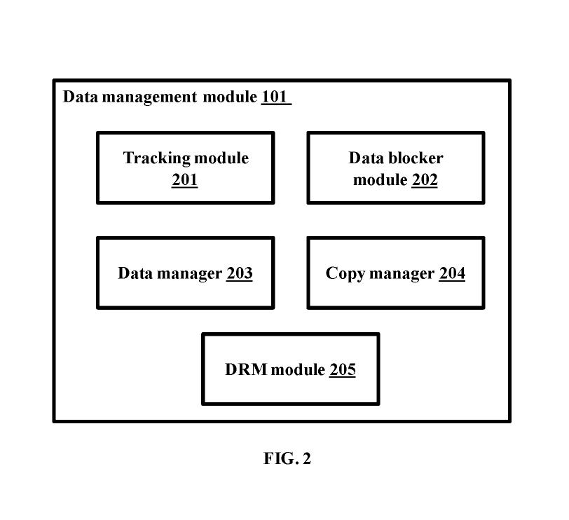

FIG. 2 depicts a data management module, according to embodiments as disclosed herein. The data management module 101 can comprise of a tracking module 201, a data blocker module 202, a data manager 203, a copy manager 204, and a DRM module 205.

The data blocker module 202 can split the data into a plurality of data blocks. The administrator can configure the size of the data blocks. In an embodiment herein, the size of the data blocks can range from a few KB (Kilobytes) to a few MB (Megabytes). The data blocker module 202 can use a suitable variable/fixed size-chunking algorithm for splitting the data in to data blocks. The data blocker module 202 can store the data blocks or fingerprints (such as signatures or hashes) of the data blocks in a suitable location such as the database 104. In an embodiment herein, the data blocker module 202 can store the requested information in a dedicated database (hereinafter referred to as a data block database). In an embodiment herein, the data block database can be integrated into the database 104. In an embodiment herein, the data block database can be a dedicated database, separate from the database 104.

The data manager 203 can receive incoming requests for access from the user and/or the device 102. The data manager 203 can check whether the user and/or the device 102 have the requisite permissions to access the data. If the user and/or the device 102 have the requisite permissions to access the data, the data manager 203 can enable the user and/or the device 102 to access the data. The data manager 203 can further manage the access of data, along with sharing of the data among a plurality of user and/or devices. If the device is a managed device 102a, the data manger 203 can enable access to the original data or the DRM data, based on the permissions associated with the data. If the device is an unmanaged device 102b, the data manger 203 can enable access only to the DRM data. The data manager 203 can ensure that access permissions with respect to the data, policies and so on are enforced, with the DRM module 205. The data manager 203 can ensure that permissions with respect to sharing of the data, policies and so on are enforced, with the DRM module 205.

The DRM module 205 can encrypt the data and associate at least one right with the data. The DRM module 205 can encrypt the data in real time (on receiving a request for the data or the data being shared and so on). The DRM module 205 can encrypt the data and store the data in a suitable location such as the database 104. The at least one right to be associated with the data can be provided by the administrator. In an embodiment herein, the DRM module 205 can enable the user to access the data using a dedicated application, wherein the dedicated application can assist in enforcing the rights. In case of an unmanaged device 102b, the DRM module 205 can monitor the data.

The tracking module 201 can keep track of requests received from a device 102, wherein the request can be for access to copies of data. The tracking module 201 can capture the identification means of the user and/or the device 102, who made the request. The identification means for the user can comprise of name of the user, the credentials of the user (if applicable), and so on. The identification means for the device 102 can comprise of whether the device 102 is a managed device 102a or an unmanaged device 102b, a unique identification means of the device 102 (such as a MAC address, and so on), the location of the device 102, the IP (Internet Protocol) address of the device 102, and so on. The tracking module 201 can also collect any other information related to the request, such as the date and time of the request, the type of data requested, extent of access to the data requested and so on. The tracking module 201 can store the requested and information in a suitable location such as the database 104. In an embodiment herein, the tracking module 201 can store the requested information in a dedicated database (hereinafter referred to as a tracking database). In an embodiment herein, the tracking database can be integrated into the database 104. In an embodiment herein, the tracking database can be a dedicated database, separate from the database 104.

The copy manager 204 can check for copies of data across devices, accessible to the data management module 101. The copy manager 204 can check for copies at periodic intervals, as configured by the administrator. The copy manager 204 can check for copies at specific time(s), as configured by the administrator. The copy manager 204 can check for copies on at least one event occurring, such as data being copied, data being accessed and so on. The administrator can configure the event(s). The copy manager 204 can check for copies on all devices accessible to the data management module 101. The copy manager 204 can check for copies on one or more device(s). The copy manager 204 can check for copies of data by comparing at least one original data with the data present on the devices. The copy manager 204 can perform the comparison by comparing the blocks of data, wherein the blocks of data are as split by the data blocker module 202. The copy manager 204 can perform the comparison by comparing the fingerprints of the data blocks. On finding same or similar data, the copy manager 204 can send an indication to the data manager 203. The indication can comprise of the devices on which the copies have been found (including a unique identification means for the device such as MAC address, IP address, user name, domain, user identity and so on) (as provided by the tracking module 201), the data of which the copies have been found and so on.

The data manager 203, on receiving an indication from the copy manager 204 that copies of the data are present. The data manager 203 checks if action(s) need to be taken with respect to the copies, as defined by at least one policy (as defined by the administrator). In an example, if the copies are not authorized to be present on the device, the data manager 203 can block access to the data using a suitable means such as wiping the data, locking the data, encrypting the data, DRM-protecting the data and so on.

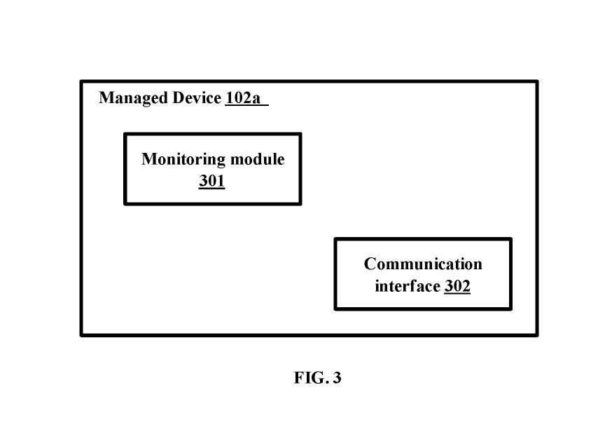

FIG. 3 depicts a managed device, according to embodiments as disclosed herein. The managed device 102a comprises of a monitoring module 301 and a communication interface 302. In an embodiment herein, the managed device 102a further comprises of an application, for enabling the user of the managed device 102a to access the data. The communication interface 302 can enable the managed device 102a to communicate with external entities, such as the data management module 101. The communication interface 302 can use a suitable wired and/or wireless connection means for communication.

On the user accessing the data, the monitoring module 201 can monitor the data and action(s) (if any), performed by the user related to the data. The monitoring module 201, in conjunction, with the data management module 101 can enforce at least one right on the data, being accessed by the user. The monitoring module 201 can raise an alert to the data management module 101, on detecting at least one pre-defined action, such as making copies of the data, sharing the data with at least one user and/or device and so on. The monitoring module 201 can further perform at least one action on the data, on receiving instructions from the data management module 101. The action can comprise of wiping the data, locking the data, encrypting the data and so on.

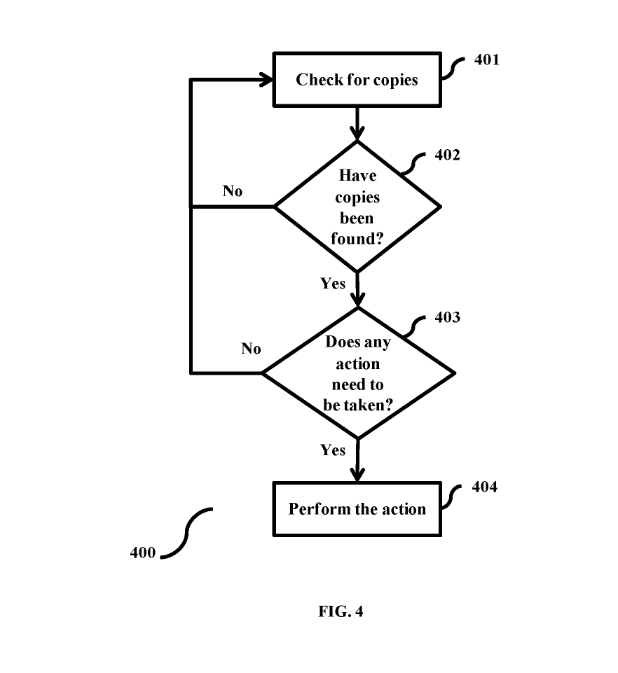

FIG. 4 is a flowchart depicting the process of managing copies of data, according to embodiments as disclosed herein. The data management module 101 checks (401) for copies of data on at least one device, accessible to the data management module 101. The data management module 101 checks for copies at periodic intervals, as configured by the administrator. The data management module 101 checks for copies at specific time(s), as configured by the administrator. The data management module 101 checks for copies on at least one event occurring, such as data being copied, data being accessed and so on. On finding similar data (402), the data management module 101 checks (403) if action(s) need to be taken with respect to the copies, as defined by at least one policy (as defined by the administrator). If at least one action needs to be performed, the data management module 101 performs (404) the action. The various actions in method 400 may be performed in the order presented, in a different order or simultaneously. Further, in some embodiments, some actions listed in FIG. 4 may be omitted.

The embodiment disclosed herein specifies a method and system for managing copies of data present within a network. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high-speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for managing copies of data present in a network, the method comprising
checking for at least one copy of the data on at least one device by a data management module, wherein the at least one device can be a managed device and an unmanaged device by comparing blocks of data with data present on the at least one device; and
performing at least one action related to at least one detected copy of the data on at least one device by the data management module, based on at least one policy related to the data.

2. The method, as claimed in claim 1, wherein the method further comprises of applying at least one DRM (Digital Rights Management) policy.

3. The method, as claimed in claim 1, wherein the managed device accesses the data directly.

4. The method, as claimed in claim 1, wherein the managed device accesses the data using a dedicated application.

5. The method, as claimed in claim 1, wherein the unmanaged device accesses the data using a dedicated application.

6. The method, as claimed in claim 1, wherein comparing the blocks of data with data present on the at least one device comprises at least one of
comparing the blocks of data directly with data present on the at least one device; and
comparing fingerprints of the blocks of data with data present on the at least one device.

7. A system for managing copies of data present in a network, the system configured for
checking for at least one copy of the data on at least one device, wherein the at least one device can be a managed device and an unmanaged device by comparing blocks of data with data present on the at least one device; and
performing at least one action related to at least one detected copy of the data on at least one device, based on at least one policy related to the data.

8. The system, as claimed in claim 7, wherein the system is further configured for applying at least one DRM (Digital Rights Management) policy.

9. The system, as claimed in claim 7, wherein the system is further configured for enabling the managed device to access the data directly.

10. The system, as claimed in claim 7, wherein the system is further configured for enabling the managed device to access the data using a dedicated application.

11. The system, as claimed in claim 7, wherein the system is further configured for enabling the unmanaged device to access the data using a dedicated application.

12. The system, as claimed in claim 7, wherein the system is further configured for comparing the blocks of data with data present on the at least one device by at least one of
comparing the blocks of data directly with data present on the at least one device; and
comparing fingerprints of the blocks of data with data present on the at least one device.
